(19) United States
(12) Patent Application Publication
(10) Pub. No.: US 2024/0195754 A1
(43) Pub. Date: Jun. 13, 2024

(54) Allocation of shared reserve memory

(71) Applicant: MELLANOX TECHNOLOGIES, LTD., Yokneam (IL)

(72) Inventors: Niv Aibester, Herzliya (IL); Barak Gafni, Sunnyvale, CA (US)

(21) Appl. No.: 18/581,423

(22) Filed: Feb. 20, 2024

Related U.S. Application Data
(63) Continuation of application No. 17/588,385, filed on Jan. 31, 2022, now Pat. No. 11,973,696.

(51) Int. Cl. H04L 49/103; H04L 45/122; H04L 47/30; H04L 49/9005; H04L 49/9047

(52) U.S. Cl. CPC H04L 49/103; H04L 45/122; H04L 47/30; H04L 49/9005; H04L 49/9047

(57) ABSTRACT

A device includes ports, a packet processor, and a memory management circuit. The ports communicate packets over a network. The packet processor processes the packets using queues. The memory management circuit maintains a shared buffer in a memory and adaptively allocates memory resources from the shared buffer to the queues, maintains in the memory, in addition to the shared buffer, a shared-reserve memory pool for use by the queues, identifies, among the queues, a queue that requires additional memory resources, the queue having an occupancy that is (i) above a current value of a dynamic threshold, rendering the queue ineligible for additional allocation from the shared buffer, and (ii) no more than a defined margin above the current value of the dynamic threshold, rendering the queue eligible for allocation from the shared-reserve memory pool, and allocates memory resources to the identified queue from the shared-reserve memory pool.

### CROSS-REFERENCE TO RELATED APPLICATIONS

This application is a continuation of U.S. patent application Ser. No. 17/588,385, filed Jan. 31, 2022, whose disclosure is incorporated herein by reference.

### FIELD OF THE INVENTION

The present invention relates generally to network communication, and particularly to management of memory resources in network devices.

### BACKGROUND OF THE INVENTION

Some network devices, such as packet switches, use shared memory schemes for efficient storage of packets and other data. For example, U.S. Pat. No. 10,250,530 describes techniques for flexible buffer allocation in a network switch. The patent describes a communication apparatus that includes multiple interfaces configured to be connected to a packet data network for receiving and forwarding of data packets of multiple types. A memory is coupled to the interfaces and configured as a buffer to contain packets received through the ingress interfaces while awaiting transmission to the network via the egress interfaces. Packet processing logic is configured to maintain multiple transmit queues, which are associated with respective ones of the egress interfaces, and to place both first and second queue entries, corresponding to first and second data packets of the first and second types, respectively, in a common transmit queue for transmission through a given egress interface, while allocating respective spaces in the buffer to store the first and second data packets against separate, first and second buffer allocations, which are respectively assigned to the first and second types of the data packets.

### SUMMARY OF THE INVENTION

An embodiment of the present invention that is described herein provides a network device including one or more ports, a packet processor, and a memory management circuit. The one or more ports are to communicate packets over a network. The packet processor is to process the packets using a plurality of queues. The memory management circuit is to maintain a shared buffer in a memory and adaptively allocate memory resources from the shared buffer to the queues, to maintain in the memory, in addition to the shared buffer, a shared-reserve memory pool for use by a defined subset of the queues, to identify in the subset a queue that (i) requires additional memory resources, (ii) is not eligible for additional allocation from the shared buffer, and (iii) meets an eligibility condition for the shared-reserve memory pool, and to allocate memory resources to the identified queue from the shared-reserve memory pool.

In an embodiment, the memory management circuit is to identify that the queue requires additional memory resources by receiving a request from the queue. In some embodiments, the memory management circuit is to identify that the queue is not eligible for additional allocation from the shared buffer, by identifying that the occupancy of the queue exceeds a MAX threshold set for the queue. In an example embodiment, the memory management circuit is to verify that the occupancy of the queue meets the eligibility condition for the shared-reserve memory pool, by verifying that the occupancy is no more than a defined margin above the MAX threshold.

In a disclosed embodiment, the memory management circuit is to pre-allocate to the queue a private-reserve memory resource, irrespective of the shared buffer and the shared-reserve memory pool. In an embodiment, the queues in the subset are associated with a same port of the network device.

There is additionally provided, in accordance with an embodiment that is described herein, a memory management circuit in a network device. The memory management circuit includes one or more interfaces and circuitry. The one or more interfaces are to communicate with a plurality of queues of the network device that process packets, and with a memory. The circuitry is to maintain a shared buffer in the memory and adaptively allocate memory resources from the shared buffer to the queues, to maintain in the memory, in addition to the shared buffer, a shared-reserve memory pool for use by a defined subset of the queues, to identify in the subset a queue that (i) requires additional memory resources, (ii) is not eligible for additional allocation from the shared buffer, and (iii) meets an eligibility condition for the shared-reserve memory pool, and to allocate memory resources to the identified queue from the shared-reserve memory pool.

There is also provided, in accordance with an embodiment that is described herein, a method for communication in a network device. The method includes communicating packets over a network, and processing the packets using a plurality of queues. A shared buffer is maintained in a memory, and memory resources are allocated adaptively from the shared buffer to the queues. In addition to the shared buffer, a shared-reserve memory pool is maintained in the memory for use by a defined subset of the queues. A queue that (i) requires additional memory resources, (ii) is not eligible for additional allocation from the shared buffer, and (iii) meets an eligibility condition for the shared-reserve memory pool, is identified in the subset. Memory resources are allocated to the identified queue from the shared-reserve memory pool.

There is further provided, in accordance with an embodiment that is described herein, a method for memory management in a network device. The method includes communicating with a plurality of queues of the network device that process packets, and with a memory. A shared buffer is maintained in a memory, and memory resources are allocated adaptively from the shared buffer to the queues. In addition to the shared buffer, a shared-reserve memory pool is maintained in the memory for use by a defined subset of the queues. A queue that (i) requires additional memory resources, (ii) is not eligible for additional allocation from the shared buffer, and (iii) meets an eligibility condition for the shared-reserve memory pool, is identified in the subset. Memory resources are allocated to the identified queue from the shared-reserve memory pool.

There is additionally provided, in accordance with an embodiment that is described herein, a method for memory management in a network device that processes packets using queues. The method includes maintaining in a memory (i) a shared buffer and (ii) shared-reserve memory pool. A queue that (i) requires additional memory resources, (ii) is not eligible for additional allocation from the shared buffer, and (iii) is eligible for allocation from the shared-reserve memory pool, is identified. Memory resources are allocated to the identified queue from the shared-reserve memory pool.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a network device comprising a shared buffer, a private reserve memory and a shared reserve memory pool, in accordance with an embodiment of the present invention;

FIG. 2 is a diagram that schematically illustrates occupancy thresholds and ranges used for allocating memory resources to a queue in the network device of FIG. 1, in accordance with an embodiment of the present invention; and

FIG. 3 is a flow chart that schematically illustrates a method for allocating memory resources to queues in the network device of FIG. 1, in accordance with an embodiment of the present invention.

### DETAILED DESCRIPTION OF EMBODIMENTS

### Overview

Embodiments of the present invention that are described herein provide improved methods and apparatus for allocating memory resources to queues in network devices, e.g., in packet switches.

In some embodiments, a network device comprises one or more ports for sending and receiving packets over a network, and a packet processor that processes the packets. As part of the packet processing, the packet processor queues the packets in a plurality of queues. In a typical implementation, a given port is assigned separate receive and transmit queues. The packets of a given direction (receive or transmit) are queued in separate queues according to their priority group. Typically, the packet data is stored in a memory, and the queues store descriptors or pointers that point to the data.

In real-life network devices, traffic load may vary significantly from one port to another and/or over time. Consequently, the memory requirements of the queues are typically highly variable, as well. Since the overall memory resources of the network device are limited, memory allocation to the queues has to be fast, flexible and efficient in order to maintain high throughput and avoiding congestion. In some embodiments of the present invention, the network device comprises a Memory Management Circuit (MMC) that manages the memory resources of the network device, including allocating suitable memory resources to the various queues.

In some embodiments, the MMC maintains three different types of memory regions in the memory, referred to as a shared buffer, a private reserve memory and a shared reserve memory pool. The MMC allocates memory resources from the three regions to the queues according to criteria that are described herein.

Resources of the private reserve memory are typically allocated a-priori to the queues, and remain allocated to the same queues regardless of actual queue occupancies. Such a-priori, static allocation enables the queues to respond immediately to fast-developing traffic bursts.

Memory resources of the shared buffer are typically allocated to the queues adaptively, depending on individual queue occupancy. Typically, a highly active and full queue will be allocated more memory from shared buffer 44, whereas an idle queue will receive little or no shared-buffer allocation. A queue will typically begin requesting allocation from the shared buffer after it has exhausted its pre-allocated private-reserve allocation. The shared buffer allocation mechanism maintains fairness among the active queues.

In some embodiments, the MMC defines a maximal occupancy (referred to herein as a “MAX-STATE” threshold), above which a queue is not eligible to receive additional allocations from the shared buffer. The MAX-STATE threshold is adaptive and depends on the overall demand for shared-buffer resources. When the overall demand for shared-buffer resources is high, e.g., when some queues experience congestion, the MMC will reduce the MAX-STATE threshold. When the overall demand for shared-buffer resources is low, the MMC will increase the MAX-STATE threshold. This mechanism introduces a certain degree of fairness among the queues in competing for shared buffer resources.

In practice, the above-described allocation scheme may be problematic in some scenarios. Consider, for example, a scenario in which one queue has a relatively low activity level and small occupancy, while other queues are highly active and full. With the above-described allocation schemes, the large and busy queues will receive large allocations from the shared buffer, and will cause the MMC to reduce the MAX-STATE threshold. As a result, the low-activity queue may become ineligible for shared-buffer allocation. In such a situation, the low-activity queue may not cope well with bursts of packets, e.g., may become congested or drop packets.

As seen in this example, a low-activity queue may suffer from the fact that higher-activity queues dominate the shared-buffer allocations. This scenario is especially problematic because a low-activity queue will also typically receive a small private-reserve allocation to begin with.

In some embodiments the MMC avoids the above-described scenario, and possibly other problematic scenarios, using the resources of the shared reserve memory pool. In these embodiments, the MMC defines an additional range of occupancy levels, above the MAX-STATE threshold, in which a queue is eligible for allocation from the shared reserve memory pool. In an embodiment, the MMC identifies a queue that requires additional memory but is too full to be eligible for allocation from the shared buffer (i.e., a queue whose occupancy exceeds the MAX-STATE threshold). If the occupancy level of the queue is not too high above the MAX-STATE threshold (e.g., up to a predefined margin above the MAX-SATATE threshold), the MMC allocates to the queue additional memory from the shared reserve memory pool. The shared-reserve mechanism thus ensures that a small and relatively idle queue will not be starved of memory resources due to high demand from other queues.

In some embodiments, the MMC maintains multiple separate shared reserve memory pools for multiple respective subsets of queues. For example, the MMC may maintain a shared reserve memory pool for the queues of a respective port.

Several example implementations of the disclosed memory allocation scheme are described herein.

### System Description

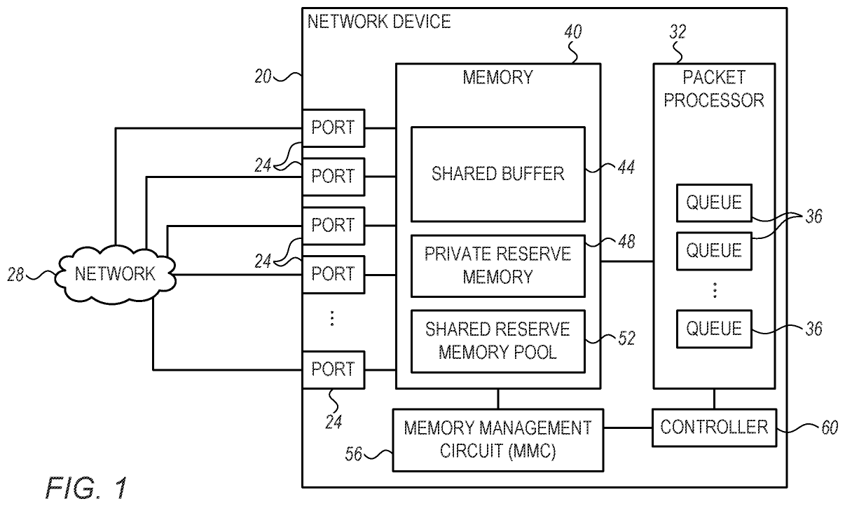

FIG. 1 is a block diagram that schematically illustrates a network device 20, in accordance with an embodiment of the present invention. Network device 20 may comprise, for example, a switch, a router, a network adapter such as a Network Interface Controller (NIC), or any other suitable network device that processes packets. The description that follows will refer mainly to a packet switch, by way of example.

Network device 20 comprises one or more ports 24 for receiving packets from a packet network 28 and/or for transmitting packets to network 28. A switch or router typically comprises a plurality of ports 24. A network adapter may comprise a single port 24 or multiple ports 24. Network 28 and network device 20 may operate in accordance with any suitable network communication protocol, such as, for example, Ethernet, InfiniBand™ or the Nvidia forwarding protocol (“NVL”).

Network device 20 further comprises a packet processor 32, which processes the packets that are received and transmitted via ports 24. In a switch, for example, packet processor 32 forwards each incoming packet to a suitable port for transmission.

As part of the processing of packets, packet processor 32 queues the packets in multiple queues 36. In practice, queues 36 typically do not store the actual packet data, but rather descriptors, pointers or other metadata that points to the packets. For clarity, queuing of this sort is also referred to herein as “queuing the packets.” In an example embodiment, for a given port 24, separate queues are designated for reception (“ingress”) and for transmission (“egress”). For a given direction (transmission or reception), separate queues are designated for different priority groups being used.

Network device 20 further comprises a memory 40 that stores, inter alia, the packet data including headers and/or payloads. Resources of memory 40 can be allocated to the various queues 36 for storage of packets. Three separate memory regions are defined in memory 40, namely a shared buffer 44, a private reserve memory 48 and a shared reserve memory pool 52. In alternative embodiments, at least some of the regions of memory 40 (e.g., shared buffer 44) may reside externally to the network device.

Memory 40 is managed by a Memory Management Circuit (MMC) 56. Among other tasks, MMC 56 defines shared buffer 44, private reserve memory 48 and shared reserve memory pool 52, and allocates memory resources from the various memory regions to queues 36. Example allocation schemes are described in detail below. MMC 56 typically comprises one or more interfaces for communicating with queues 36 and with memory 40, and circuitry for performing the memory allocation tasks described herein.

Network device 20 further comprises a controller 60, which performs various control-plane and management tasks.

The configurations of network device 20 and its various components, such as packet processor 32, MMC 56 and memory 40, are example configurations that are chosen purely for the sake of conceptual clarity. Any other suitable configurations can be used in alternative embodiments. In various embodiments, network device 20 and its various components can be implemented using hardware, e.g., using one or more Application-Specific Integrated Circuits (ASIC) and/or Field-Programmable Gate Arrays (FPGA), using software, or using a combination of hardware and software components. Memory 40 typically comprises a suitable Random-Access Memory (RAM).

In some embodiments, certain components of network device 20, e.g., controller 60 and possibly some of functions of MMC 56, may be implemented using a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Memory Allocation Using Shared Buffer, Private Reserve Memory and Shared Reserve Memory

In some embodiments of the present invention, Memory Management Circuit (MMC) 56 allocates memory resources to the various queues 36 from (i) shared buffer 44, (ii) private reserve memory 48 and (iii) shared reserve memory pool 52. Each of these memory regions has its own characteristics. MMC 53 allocates the resources of each region in accordance with different criteria.

Memory resources of private reserve memory 48 are typically allocated by MMC 56 a-priori to queues 36 (or to at least some of queues 36). The private-reserve memory typically remains allocated to the same queues regardless of actual queue occupancies. This allocation allows queues 36 to respond immediately to traffic bursts and maintain forward progress, even in a congested device. The size of the private-reserve allocation may differ from one queue to another. Further aspects of using a private reserve memory are addressed, for example, in U.S. patent application Ser. No. 17/503,383, entitled “Dynamic Reserve Allocation on Shared-Buffer,” filed Oct. 18, 2021.

Memory resources of shared buffer 44 are typically allocated by MMC 56 adaptively, depending on individual queue occupancy. Typically, a highly active and full queue 36 will be allocated more memory from shared buffer 44, whereas an idle queue will receive little or no shared-buffer allocation. Aspects of shared-buffer allocation are addressed, for example, in U.S. Pat. No. 10,250,530, cited above. A queue will typically begin requesting allocation from shared buffer 44 after it has exhausted its private-reserve allocation (that was pre-allocated from private reserve memory 48).

In some embodiments, MMC 56 defines a maximal occupancy (referred to herein as a “MAX-STATE” threshold), above which a queue 36 is not eligible to receive additional allocations from shared buffer 44. Unless assisted by the disclosed technique, a queue that is ineligible to receive additional allocations from the shared buffer may drop packets (in lossy traffic implementations) or make excessive use of flow control (e.g., credits, in lossless traffic implementations).

The MAX-STATE threshold is adaptive and depends on the overall demand for shared-buffer resources. When the overall demand for shared-buffer resources is high, e.g., when some queues experience congestion, MMC 56 will typically reduce the MAX-STATE threshold. When the overall demand for shared-buffer resources is low, MMC 56 will typically increase the MAX-STATE threshold. This mechanism introduces a certain degree of fairness among the queues in competing for the resources of shared buffer 44.

As explained above, the allocation schemes that use the shared buffer and private reserve memory may be problematic in some scenarios. For example, due to the adaptation of the MAX-STATE threshold, a low-activity queue may become ineligible for shared-buffer allocation when high-activity queues have high demand for memory.

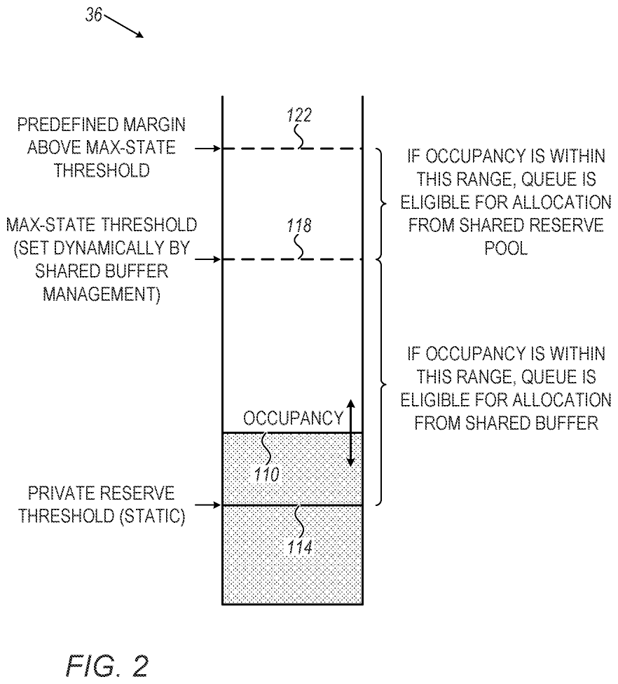

In some embodiments, MMC 56 uses the resources of shared reserve memory pool 52 to avoid such problematic scenarios. In these embodiments, MMC 56 defines an additional range of occupancy levels, above the MAX-STATE threshold, in which a queue is eligible for allocation from shared reserve memory pool 52. The various occupancy thresholds and ranges are depicted in FIG. 2 below.

In an embodiment, MMC 56 identifies a queue 36 that requires additional memory but is too full to be eligible for allocation from shared buffer 44 (i.e., a queue whose occupancy exceeds the MAX-STATE threshold). If the occupancy level of the queue is not too high above the MAX-STATE threshold (e.g., up to a predefined margin above the MAX-SATATE threshold), MMC 52 allocates to the queue memory resources from shared reserve memory pool 52.

FIG. 2 is a diagram that schematically illustrates occupancy thresholds and ranges used for allocating memory resources to a queue 36, in accordance with an embodiment of the present invention. The queue in the figure may be any of queues 36 in network device 20 of FIG. 1 above.

The occupancy of queue 36 is variable and depends on its rate of filling and rate of emptying. At a given time, queue 36 has a current occupancy level denoted 110. The private reserve allocation assigned to queue 36 is marked by a private reserve threshold 114. This level is static, i.e., does not vary depending on the actual occupancy level of the queue.

The current level of the MAX-STATE threshold is denoted 118 in the figure. As explained above, MAX-STATE threshold 118 is varied by MMC 56 depending on the overall demand for allocations from shared buffer 44. When demand is high, MMC 56 decreases MAX-STATE threshold 118, and vice versa. In a typical implementation, the MMC calculates the MAX-STATE threshold for a certain queue based on (i) the total free memory space remaining in the shared buffer and (ii) the number of queues assigned to the shared buffer pool. Thus, as the free memory space in the shared buffer decreases, the potential additional memory that can be allocated to a given queue decreases, as well.

When occupancy level 110 of queue 36 is in the range between private reserve threshold 114 and MAX-STATE threshold 118, queue 36 is eligible to receive additional allocations from shared buffer 44. (When occupancy level 110 is below this range, the queue will still have available resources from its private-reserve allocation. When occupancy level 110 is above this range, the shared-buffer management scheme will prevent allocating additional memory from the shared buffer to the queue.)

A predefined margin 122 is set by MMC 56 as an upper limit for eligibility for allocation from shared reserve memory pool 52. In other words, the range between levels 118 and 122 is predefined, and this constant-size range moves up and down following the variations of MAX-STATE threshold 118. When occupancy level 110 of queue 36 is in this range (between MAX-STATE threshold 118 and margin 122), queue 36 is eligible to receive additional allocations from shared reserve memory pool 52. (When occupancy level 110 is below this range, the queue may request allocations from shared buffer 44. When occupancy level 110 is above this range, the queue is not eligible to any additional allocations, from any source.)

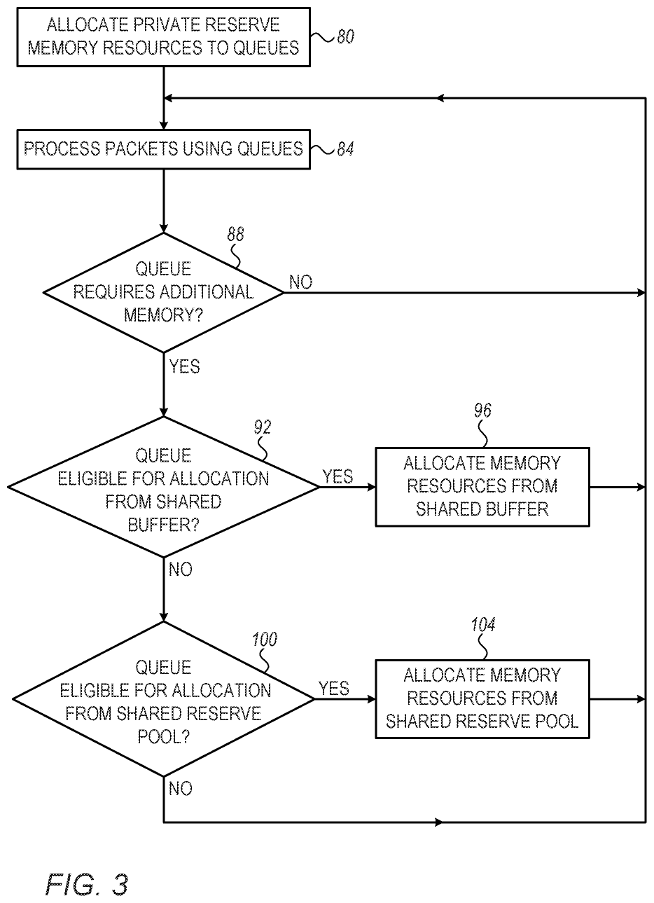

FIG. 3 is a flow chart that schematically illustrates a method, carried out by MMC 56 in network device 20, for allocating memory resources to queues 36, in accordance with an embodiment of the present invention.

The method begins with MMC 56 pre-allocating memory resources of private reserve memory 48 to queues 36, at a private reserve allocation stage 80. At a packet processing stage 84, packet processor 32 receives packets from network 28 via ports 24, processes the packets including queuing them in queues 36, and sends the processed packets back via ports 24 to network 28. At this stage, MMC 56 also performs accounting on the various queues with respect to the shared buffer.

At a requirement checking stage 88, MMC 56 checks whether any of queues 36 requires additional memory resources. In an embodiment, a queue that requires additional memory will send a suitable request to MMC 56. Thus, MMC may identify that a queue requires additional memory by identifying a request from the queue. Alternatively, MMC 56 may proactively determine that a queue requires additional memory, using any suitable method. If no queue requires additional memory (i.e., if all queues have sufficient free memory in their pre-allocated private-reserve allocations), the method loops back to packet processing stage 84.

In response to identifying that a certain queue requires additional memory, MMC 56 checks whether the queue is eligible for allocation from shared buffer 44, at a shared-buffer eligibility checking stage 92. In an embodiment, MMC checks whether the current occupancy (110) of the queue is (i) higher than private-reserve threshold 114 and (ii) lower than MAX-STATE threshold 118. If so, MMC allocates memory resources from shared buffer 44 to the queue, at a shared-buffer allocation stage 96. The method then loops back to packet processing stage 84.

If the outcome of stage 92 is that the queue is not eligible for allocation from shared buffer 44, MMC 56 checks whether the queue is eligible for allocation from shared reserve memory pool 52, at a shared-reserve eligibility checking stage 100. In an embodiment, MMC checks whether the current occupancy (110) of the queue is (i) higher than MAX-STATE threshold 118 and (ii) lower than margin 122. If so, MMC allocates memory from shared reserve memory pool 52 to the queue, at a shared-reserve allocation stage 104. The method then loops back to packet processing stage 84.

If the outcome of stage 100 is that the queue is not eligible for allocation from shared reserve memory pool 52, the method loops back to packet processing stage 84 without allocating any additional memory to the queue.

The method flow of FIG. 3 is an example flow that is depicted purely for the sake of conceptual clarity. In alternative embodiments, the disclosed techniques can be implemented using any other suitable flow.

For example, the method can be divided into two separate processes that are executed in parallel. One process is a shared-buffer management process, which allocates memory from shared buffer 44 and adapts MAX-STATE threshold 118. The other process is a shared-reserve management process, which allocates memory from shared reserve memory pool 52. The variations in MAX-STATE threshold 118 affect both processes, since they affect both eligibility ranges (eligibility for shared-buffer allocation, and eligibility for shared-reserve allocation). As another example, the method can be used with a shared-buffer mechanism that uses a static (i.e., non-variable) MAX-STATE threshold.

As yet another example, MMC 56 may define a hierarchy of shared-reserve memory pools 52. The hierarchy may comprise, for example, a “global” shared-reserve pool, plus shard-reserve pools for receive (ingress) queues, for multicast (MC) queues, for transmit (egress) queues, and the like. When a certain shared-reserve pool is exhausted, the MMC may allocate additional memory to this pool from the global shared-reserve pool.

The description up to this point referred to a single shared reserve memory pool 52, whose resources may be allocated to any of queues 36 in network device 20. In some embodiments, MMC 56 maintains multiple separate shared reserve memory pools 52 in memory 40. Each shared reserve memory pool 52 is assigned to a respective subset of queues 36. In other words, in these embodiments MMC 56 allocates to a given queue only shared-reserve allocations from the pool 52 of the subset of queues to which the given queue belongs. For example, MMC 52 may maintain a separate pool 52 for the receive queues of each port 48, and/or to the transmit queues of each port. In an example embodiment, a given port 24 is assigned a set of queues 36 corresponding to respective priority groups, and MMC 56 maintains a shared reserve memory pool 52 for this set of queues. As another example, MMC 52 may maintain a separate pool 52 for any other group of (receive or transmit) queues.

In an example embodiment, MMC 56 carries out the disclosed technique by executing the pseudo-code sections below. The present example considers a receive queue Rq[] of a certain port 24. Several priority groups pg[] are defined for this receive queue, and each priority group is assigned a separate queue 36. These queues are thus denoted Rq[],pg[].

Attributes denoted Rq[].SharedReserve and Rq[].SharedReserveTH are defined for Rq[]. Rq[].SharedReserve is the overall size of the allocation from shared reserve memory pool 52, allocated to the various queues 36 belonging to Rq[]. Rq[].SharedReserveTH denotes the size of the shared reserve pool. In addition, attributes denoted Rq.Pg[].PrivateReserve, Rq.Pg[].PrivateReserveTH and Rq.Pg[].ReserveEligibleTH are defined for each priority group Pg[] of receive queue Rq[]. Rq.Pg[].PrivateReserve is the size of the private-reserve allocation that was allocated to queue Rq.Pg[]. Rq.Pg[].PrivateReserveTH denotes the upper threshold for allocating memory to the queue from the private reserve pool. Rq.Pg[].ReserveEligibleTH denotes the margin (range) above the MAX-TH threshold within which the queue is eligible for allocation from the shared reserve pool.

In this example, the allocation process is performed in accordance with the following pseudo-code:
1. If Inc. & Rq.pg[].Occupancy<PrivateReserve[]→Done, HaveReserve for Rq.Pg[]
2. If Inc. & (Rq.Pg[].PrivateReserveTH[]<(Rq.pg[].Occupancy)<(Rq.Pg[].PrivateReserveTH[]+Rq.Pg[].ReserveEligibleTH)&(Published Rq.pg[].AboveMax)
   a. If Rq[].SharedReserve<Rq[].SharedReserveTH
      i. Increase Rq[].SharedReserve by Delta
      ii. Increase Rq.Pg[].PrivateReserve[] by Delta
   b. If Rq[].SharedReserve>Rq[].SharedReserveTH→Done, NoReserve for Rq.Pg[]
3. If Dec. & Rq.pg[] & (Rq.Pg[].PrivateReserve[]>Rq.Pg[].PrivateReserveTH[])
   a. Decrease Rq.Pp[].PrivateReserve[] by Delta
   b. Decrease Rq[].SharedReserve by Delta

In parallel, an additional “crawler process” is performed according to the following pseudo-code:
4. If (˜Rq.pg[].AboveMax) & (Rq.Pg[].PrivateReserve[]>Rq.Pg[].PrivateReserveTH[])
   a. Decrease Rq.Pp[].PrivateReserve[] by Delta
   b. Decrease Rq[].SharedReserve by Delta

In the pseudo-code above, Rq.pg[].Occupancy denotes the current occupancy (110) of the queue Rq.pg[], Inc. denotes a detected increase in the current occupancy, and Dec. denotes a detected decrease in the current queue occupancy. HaveReserve for Rq.Pg[] is an outcome indicating that the queue currently has sufficient reserve memory, whereas NoReserve for Rq.Pg[] is an outcome indicating that the queue does not have sufficient reserve memory.

Published Rq.pg[].AboveMax is a Boolean attribute that indicates whether the current occupancy of queue Rq.pg[] is above MAX-STATE threshold 118. Delta denotes the increment by which MMC 56 increases or decreases the reserve allocations.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A device, comprising:
one or more ports, to communicate packets over a network;
a packet processor, to process the packets using a plurality of queues; and
a memory management circuit, to:
maintain a shared buffer in a memory, and adaptively allocate memory resources from the shared buffer to the queues;
maintain in the memory, in addition to the shared buffer, a shared-reserve memory pool for use by one or more of the queues;
identify, among the queues, a queue that requires additional memory resources, the queue having an occupancy that is:
(i) above a current value of a dynamic threshold, rendering the queue ineligible for additional allocation from the shared buffer, and
(ii) no more than a defined margin above the current value of the dynamic threshold, rendering the queue eligible for allocation from the shared-reserve memory pool; and
allocate memory resources to the identified queue from the shared-reserve memory pool.

2. The device according to claim 1, wherein the memory management circuit is to identify that the queue requires additional memory resources by receiving a request from the queue.

3. The device according to claim 1, wherein the memory management circuit is to pre-allocate to the queue a private-reserve memory resource, irrespective of the shared buffer and the shared-reserve memory pool.

4. The device according to claim 1, wherein the queues are associated with a same port of the network device.

5. A memory management circuit, comprising:
one or more interfaces, to communicate with a plurality of queues of the network device that process packets, and with a memory; and
circuitry, to:
maintain a shared buffer in the memory, and adaptively allocate memory resources from the shared buffer to the queues;
maintain in the memory, in addition to the shared buffer, a shared-reserve memory pool for use by one or more of the queues;
identify, among the queues, a queue that requires additional memory resources, the queue having an occupancy that is:
(i) above a current value of a dynamic threshold, rendering the queue ineligible for additional allocation from the shared buffer, and
(ii) no more than a defined margin above the current value of the dynamic threshold, rendering the queue eligible for allocation from the shared-reserve memory pool; and
allocate memory resources to the identified queue from the shared-reserve memory pool.

6. The memory management circuit according to claim 5, wherein the circuitry is to identify that the queue requires additional memory resources by receiving a request from the queue.

7. The memory management circuit according to claim 5, wherein the circuitry is to pre-allocate to the queue a private-reserve memory resource, irrespective of the shared buffer and the shared-reserve memory pool.

8. The memory management circuit according to claim 5, wherein the queues are associated with a same port of the network device.

9. A method for communication, the method comprising:
communicating packets over a network, and processing the packets using a plurality of queues;
maintaining a shared buffer in a memory, and adaptively allocating memory resources from the shared buffer to the queues;
maintaining in the memory, in addition to the shared buffer, a shared-reserve memory pool for use by one or more of the queues;
identifying, among the queues, a queue that requires additional memory resources, the queue having an occupancy that is:
(i) above a current value of a dynamic threshold, rendering the queue ineligible for additional allocation from the shared buffer, and
(ii) no more than a defined margin above the current value of the dynamic threshold, rendering the queue eligible for allocation from the shared-reserve memory pool; and
allocating memory resources to the identified queue from the shared-reserve memory pool.

10. The method according to claim 9, wherein identifying that the queue requires additional memory resources comprises receiving a request from the queue.

11. The method according to claim 9, wherein further comprising pre-allocate to the queue a private-reserve memory resource, irrespective of the shared buffer and the shared-reserve memory pool.

12. The method according to claim 9, wherein the queues in the subset are associated with a same port of the network device.

13. A method for memory management, the method comprising:
communicating with a plurality of queues of the network device that process packets, and with a memory;
maintaining a shared buffer in the memory, and adaptively allocating memory resources from the shared buffer to the queues;
maintaining in the memory, in addition to the shared buffer, a shared-reserve memory pool for use by one or more of the queues;
identifying, among the queues, a queue that requires additional memory resources, the queue having an occupancy that is:
(i) above a current value of a dynamic threshold, rendering the queue ineligible for additional allocation from the shared buffer, and
(ii) no more than a defined margin above the current value of the dynamic threshold, rendering the queue eligible for allocation from the shared-reserve memory pool; and
allocating memory resources to the identified queue from the shared-reserve memory pool.

14. A method for memory management using queues, the method comprising:
maintaining in a memory (i) a shared buffer and (ii) a shared-reserve memory pool;
identifying a queue that requires additional memory resources and has an occupancy that is:
(i) above a current value of a dynamic threshold, rendering the queue ineligible for additional allocation from the shared buffer, and
(ii) no more than a defined margin above the current value of the dynamic threshold, rendering the queue eligible for allocation from the shared-reserve memory pool; and
allocating memory resources to the identified queue from the shared-reserve memory pool.
